(19) United States
(12) Patent Application Publication
(10) Pub. No.: US 2021/0378210 A1
(43) Pub. Date: Dec. 9, 2021

(54) THERAPEUTIC PET BED

(71) Applicant: Ethan Hirsch, Provo, UT (US)

(72) Inventor: Ethan Hirsch, Provo, UT (US)

(21) Appl. No.: 17/340,994

(22) Filed: Jun. 7, 2021

Related U.S. Application Data
(60) Provisional application No. 62/705,065, filed on Jun. 9, 2020.

(51) Int. Cl. A01K 1/035; A61H 23/00

(52) U.S. Cl. CPC A01K 1/0353; A61H 23/00; A61H 2201/0207; A61H 2201/0142; A61H 2201/0188; A61H 2201/0134

(57) ABSTRACT

A therapeutic pet bed. The therapeutic pet bed includes a base, where the base is configured to rest on a support surface. The therapeutic pet bed also includes a cover, where the base is attached to the cover and the cover surrounds the other components of the therapeutic pet bed. The therapeutic pet bed further includes a foam base and one or more vibration motors within the foam base. The therapeutic pet bed additionally includes a heating layer and a pad, where the pad produces a rest area for the pet. The therapeutic pet bed moreover includes a control, where the control is configured to allow a user to turn on and off the heating layer and the vibration motors.

### CROSS-REFERENCE TO RELATED APPLICATIONS

This application claims the benefit of and priority to U.S. Provisional Patent Application Ser. No. 62,705,065 filed on Jun. 9, 2020, which application is incorporated herein by reference in its entirety.

### BACKGROUND OF THE INVENTION

Traditional pet beds serve only a single function. Namely, the beds are essentially a pad where the pet can lie down. This is suitable for many pets, but not for all pets.

For example, pet beds don't include a heating function. This is detrimental to pets that have pain, are older, or are smaller. These pets have a hard time retaining body heat. While some pet beds are designed to better preserve body heat, mostly that is just a side effect of the pad. I.e., the bed includes a pad and fabric, both of which will provide some minimal insulation, helping the pet to retain body heat. However, this is not nearly as effective as providing active heat to the pet.

In addition, pet beds do not include a vibration feature. Vibration reduces anxiety and relieves muscle pain. This can be especially detrimental to older pets. Pain medications may help reduce pain but as pets can't communicate their use is risky because the pet owner is essentially guessing at the amount of pain experienced by the pet.

Accordingly, there is a need in the art for a pet bed that provides active heat to the pet. In addition, there is a need in the art for a pet bed that provides vibration to a pet to reduce pain.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a therapeutic pet bed. The therapeutic pet bed includes a base, where the base is configured to rest on a support surface. The therapeutic pet bed also includes a cover, where the base is attached to the cover and the cover surrounds the other components of the therapeutic pet bed. The therapeutic pet bed further includes a foam base and one or more vibration motors within the foam base. The therapeutic pet bed additionally includes a heating layer and a pad, where the pad produces a rest area for the pet. The therapeutic pet bed moreover includes a control, where the control is configured to allow a user to turn on and off the heating layer and the vibration motors.

Another example embodiment includes a therapeutic pet bed. The therapeutic pet bed includes a base, where the base is configured to rest on a support surface. The therapeutic pet bed also includes a cover, where the base is attached to the cover, the cover is removable, the cover is washable and the cover surrounds the other components of the therapeutic pet bed. The therapeutic pet bed further includes a foam base and one or more vibration motors within the foam base. The vibration motors operate at the following frequencies: 90.73 hertz, 136.10 hertz, and 204.15 hertz. The therapeutic pet bed additionally includes a heating layer and a pad, where the pad produces a rest area for the pet. The therapeutic pet bed moreover includes a control, where the control is configured to allow a user to turn on and off the heating layer and the vibration motors.

Another example embodiment includes a therapeutic pet bed. The therapeutic pet bed includes a base, where the base is configured to rest on a support surface. The therapeutic pet bed also includes a cover, where the base is attached to the cover, the cover is removable, the cover is washable and the cover surrounds the other components of the therapeutic pet bed. The therapeutic pet bed further includes a foam base and one or more vibration motors within the foam base. The vibration motors operate at the following frequencies: 90.73 hertz, 136.10 hertz, and 204.15 hertz. Each vibration motor is housed within a bracket and daisy chained to the other vibration motors. The therapeutic pet bed additionally includes a heating layer. The heating wire includes a fabric mesh and a heating wire embedded within the fabric mesh. The therapeutic pet bed also includes a pad, where the pad produces a rest area for the pet. The therapeutic pet bed further includes batting attached along one or more edges of the pad, where the batting includes a fabric exterior filled with cotton and an inner cover, where the inner cover is interior to the cover and surrounds the other components of the therapeutic pet bed. The therapeutic pet bed moreover includes a control, where the control is configured to allow a user to turn on and off the heating layer and the vibration motors. The control includes a power button, a vibration button and a heating button.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates an example of a therapeutic pet bed;

FIG. 1B illustrates a cutaway view of an example of a therapeutic pet bed;

FIG. 1C illustrates an expanded view of an example of a therapeutic pet bed;

FIG. 2 illustrates an example of a heating layer;

FIG. 3 illustrates an example of a foam base and vibration motors; and

FIG. 4 illustrates an example of a control.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

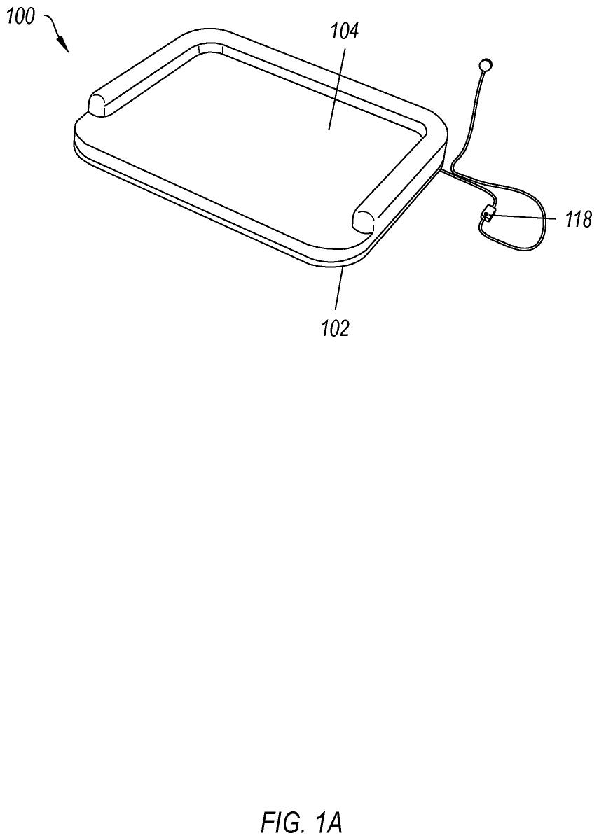

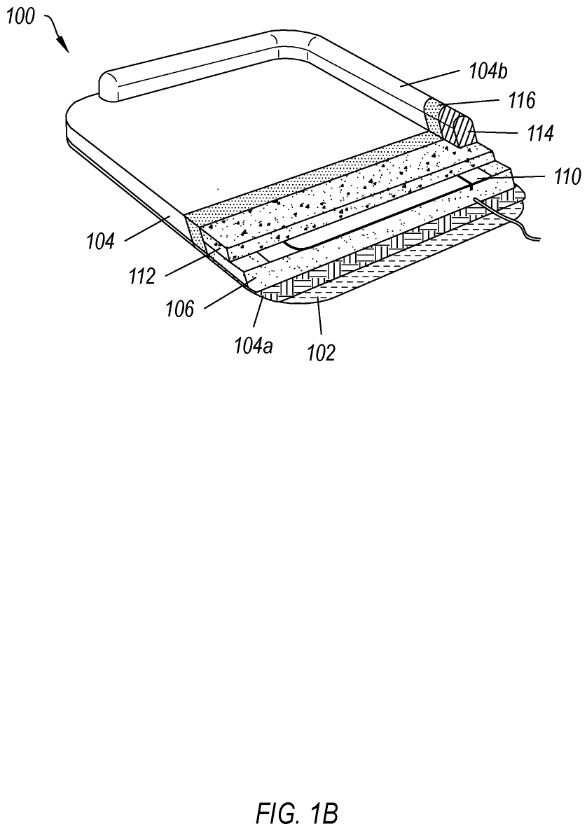

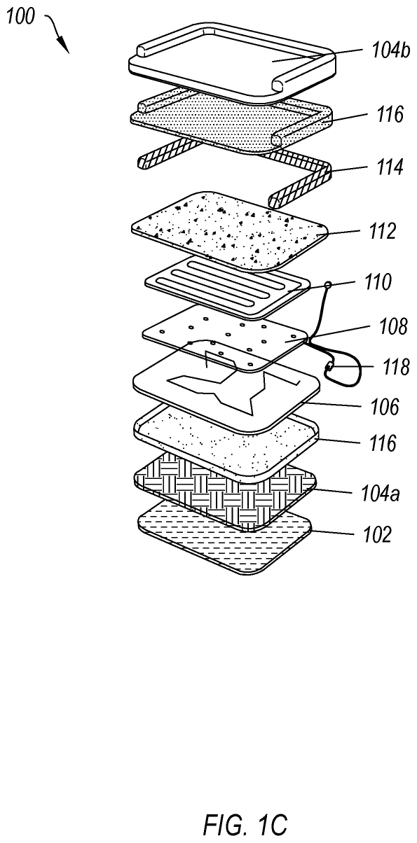

FIGS. 1A-1C (collectively “FIG. 1”) illustrate an example of a therapeutic pet bed 100. FIG. 1A illustrates an example of a therapeutic pet bed 100; FIG. 1B illustrates a cutaway view of an example of a therapeutic pet bed 100; and FIG. 1C illustrates an expanded view of an example of a therapeutic pet bed 100. The therapeutic pet bed 100 allows a pet to rest comfortably and allows the owner to provide massages to the pet in the form of vibration. In particular, the therapeutic pet bed 100 can vibrate which helps pets with anxiety and other health issues from arthritis to recovery. There are other benefits as well, such as heating functions which provide health benefits to the pet, as discussed below.

FIG. 1 also shows that the therapeutic pet bed 100 can include a base 102. The base 102 is the portion of the therapeutic pet bed 100 which is configured to rest on a floor or other support surface. The base 102 is anti-slip to prevent it from moving along the surface on which it is resting. This is critical as slippage when the pet is stepping onto or off of the therapeutic pet bed 100 can cause the pet to be unstable or fall, which could result in injury to the pet. For example, the base 102 can be made of rubber or other materials which prevent slippage. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 1 also shows that the therapeutic pet bed 100 can include cover 104 (including both a lower cover 104a and an upper cover 104b). The lower cover 104a and the upper cover 104b attach to one another and surround the components of the therapeutic pet bed 100 and are both washable. That is, the cover can be removed and washed, providing a more hygienic experience for the pet and extending the life of the other components. This allows the cover 104 to serve as a “housing” which protects other components of the therapeutic pet bed 100. The base 102 is attached to the lower cover 104a.

FIG. 1 further shows that the therapeutic pet bed 100 can include a foam base 106. The foam base 106 provides the first layer of support. That is the foam base 106 increases pet comfort and ensures that components of the therapeutic pet bed don't rest directly on the base 102, which prevents damage. The foam base 106 can include any suitable material. For example, the foam base 106 can include polyurethane foam. Foam is an object formed by trapping pockets of gas in a solid. Solid foams can be closed-cell or open-cell. In closed-cell foam, the gas forms discrete pockets, each completely surrounded by the solid material. In open-cell foam, gas pockets connect to each other. A bath sponge is an example of an open-cell foam: water easily flows through the entire structure, displacing the air. A camping mat is an example of a closed-cell foam: gas pockets are sealed from each other so the mat cannot soak up water. The foam base can be between 1.5 inches and 2.5 inches wide (top to bottom in FIG. 1). For example, the foam base 106 can be approximately 2 inches wide. As used in the specification and the claims, the term approximately shall mean that the value is within 10% of the stated value, unless otherwise specified.

FIG. 1 additionally shows that the therapeutic pet bed 100 can include one or more vibration motors 108. The vibration motors 108 are embedded within the foam base 106, as described below. The vibration motors 108 create a vibrating sensation that is transmitted through upper layers of the therapeutic pet bed 100 to create an even vibration sensation.

FIG. 1 moreover shows that the therapeutic pet bed 100 can include a heating layer 110. The heating layer 110 provides heat to the pet. Heat is well known to reduce joint pain so this is especially helpful for older pets with joint pain. In addition, for smaller pets or older pets which lose body heat more easily, the heating layer 110 can provide even heat to help preserve body heat. The heating layer 110 needs to be close enough to where the pet will lay to provide heat to the pet but not so close that it can burn the pet while turned on and needs to provide heat evenly. The heating layer 110 is described in more detail below.

FIG. 1 also shows that the therapeutic pet bed 100 can include a pad 112. The pad 112 transmits vibration and heat to the pet. In addition, the pad 112 provides a comfortable surface on which the pet will lay. I.e., the pad 112 creates a rest area for the pet. The rest area 102 is designed for maximum pet comfort. In particular, the pad 112 is a combination of firmness and softness, allowing the rest area to cradle the body of the pet, while providing needed support, as described below.

The pad 112 can be made of any material which allows vibration and heat to transmit and which provides a comfortable surface. For example, the pad 112 can be made of memory foam. Memory foam consists mainly of polyurethane as well as additional chemicals increasing its viscosity and density. It is often referred to as “viscoelastic” polyurethane foam, or low-resilience polyurethane foam (“LRPu”). The foam bubbles or ‘cells’ are open, effectively creating a matrix through which air can move. Higher-density memory foam softens in reaction to body heat, allowing it to mold to a warm body in a few minutes. Memory foam derives its viscoelastic properties from several effects, due to the internal structure of the material. The network effect is the force working to restore the structure of the foam when it is deformed. This effect is generated by the deformed porous material pushing outwards to restore its structure against an applied pressure. There are three effects which work against the network effect: the pneumatic effect, the adhesive effect, and the relaxation effect. These, combined, effectively slow the regeneration of the original structure of the foam, and allow for applications like memory foam pads. The pneumatic effect is caused by the time it takes for air to flow into the porous structure of the foam. The adhesive effect, or adhesion, is caused by the stickiness of the surfaces within the memory foam, which work against decompression, as the internal pores within the memory foam are pressed together by an applied pressure. The relaxation effect is the largest magnitude of the three forces working against expansion and is caused by the memory foam's material being near its glass transition temperature. This limits the mobility of the foam's material, forcing any change to be gradual, slowing the expansion of the foam once the applied pressure has been removed. Since this is temperature-dependent, the temperature at which a memory foam retains its properties is limited. If it is too cold, the memory foam will harden. If it is too hot, the memory foam will act like conventional foams, easily springing back to its original shape. The pneumatic and adhesive effect are strongly correlated with the size of the pores within memory foam. Smaller pores leads to higher internal surface area and reduced air flow, increasing adhesion and the pneumatic effect respectively. Thus, by changing the cell structure and porosity of the memory foam, the properties can be controlled. Moreover, by using additives in the polymeric material of the memory foam, the glass transition temperature can also be modulated, affecting the properties of the foam. The mechanical properties of memory foam can affect the comfort of mattresses produced from it. There is also a trade-off between comfort and durability. Certain memory foams may have a more rigid cell structure, leading to a weaker distribution of weight, but better recovery of the original structure, leading to improved cyclability and durability. Moreover, a denser cell structure can resist the penetration of water vapor, leading to reduced weathering and better durability and overall appearance. The pad 112 can be any width which allows heat and vibration to transmit while simultaneously providing comfort. For example, the pad can be between 0.75 and 1.25 inches wide. In particular, the pad 112 can be approximately 1 inch wide.

FIG. 1 further shows that the therapeutic pet bed 100 can include batting 114. The batting 114 prevents the pet from rolling off the therapeutic pet bed 100. In addition, the batting 114 provides an area where the pet can place his/her head for additional comfort. The batting 114 can be any suitable material. For example, the batting 114 can include a fabric covering stuffed with cotton. The batting 114 can be any desired size to provide the desired protection and comfort. For example, the batting 114 can be between 2 and 4 inches high. In particular, the batting 114 can be approximately 3 inches high.

FIG. 1 additionally shows that the therapeutic pet bed 100 can include an inner cover 116. The inner cover 116 surrounds the components of the therapeutic pet bed 100 so that when the cover 104 is removed to be washed that the components don't separate from one another. This encourages removal and washing of the cover 104 increasing hygiene.

FIG. 1 moreover shows that the therapeutic pet bed 100 can include a control 118. The control 118 allows a person to control whether the therapeutic pet bed 100 is providing heat and/or vibration to the pet. For example, the control 118 can be as simple as “on” or “off” where “on” includes both vibration and heat. Additionally or alternatively, the control 118 can allow for selection between different heat and/or vibration settings, as described below.

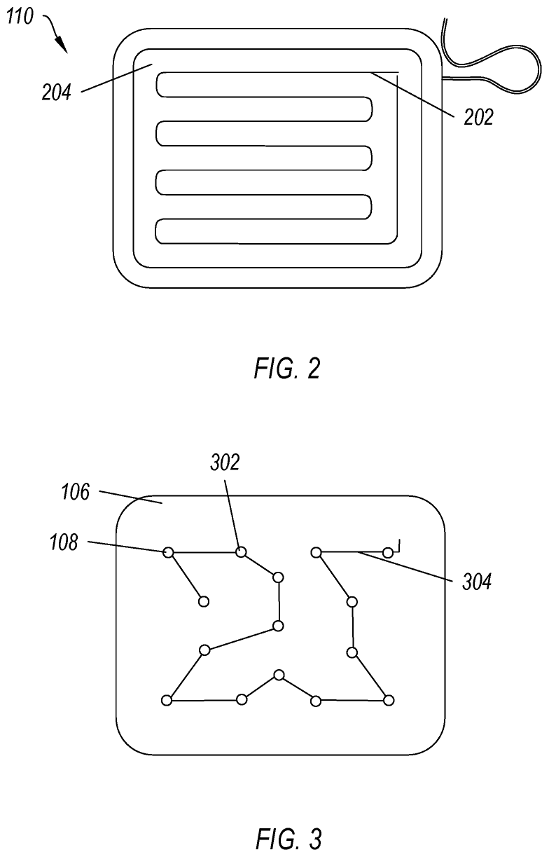

FIG. 2 illustrates an example of a heating layer 110. The heating layer 110 provides heat to the pet through the therapeutic pet bed. This is especially important as heat is known to help ease joint pain. As this is a common ailment for older pets, the application of heat can be especially helpful in providing comfort to an older pet.

The heating layer 110 cannot get overly hot or it can cause pain or burns on the pet. Consequently, the heating layer 110 needs to provide even heat and provide a maximum amount of heat. I.e., if the heating layer 110 causes hot spots, then that can be dangerous for a pet. Therefore, it is critical that the heating layer 110 have a stable temperature with heat distributed evenly. The heating layer 110 can heat to approximately 102 degrees F. (38.9 degrees C.).

FIG. 2 shows that the heating layer 100 includes a heating wire 202. The heating wire 202 converts electrical power into heat. In particular, careful composition can create a heating wire 202 with a desired resistance. This resistance can then be directly correlated to the amount of heat that will be produced based on the amount of electrical power applied to the heating wire 202.

FIG. 2 also shows that the heating layer 100 can include a fabric mesh 204. The fabric mesh 204 suspends the heating wire 202. That is, the heating wire 202 is attached to the fabric mesh 204 so that the location of the heating wire 202 remains constant, which ensures an even distribution of heat. In addition, the fabric mesh 204 transmits the heat produced by the heating wire 202 evenly so that the heat will better transmit through the padding to the pet. Finally, the fabric mesh 204 protects the heating wire 202 from damage due to excessive flexing.

FIG. 3 illustrates an example of a foam base 106 and vibration motors 108. The foam base 106 and the vibration motors 108 provide a vibration sensation that helps ease pain in pets. It is critical that the vibration be distributed evenly, otherwise the vibration is intense in one area and nonexistent in another. Further, intense vibration stops being therapeutic and instead becomes a pain point, meaning that the pet will refuse to use the therapeutic pet bed.

FIG. 3 shows that the vibration motors 108 can be evenly spaced. For example, in the example of FIG. 3 the center line of vibration motors 108 has three motors, the next line (moving outward in both directions) has two vibration motors 108 spaced far from one another, the third line includes two vibration motors 108 toward the interior and the final line of vibration motors 108 are spaced the same as the second line of vibration motors 108. This spacing can lead to an even sensation of vibration, which eliminates pain points.

FIG. 3 also shows that the vibration motors 108 are each placed in a bracket 302. The bracket 302 stabilizes the vibration motor 108 and creates a more efficient transfer of vibration. The bracket 302 can include any desired material. For example, the bracket 302 can include a stiff rubber attached to the foam base 106.

FIG. 3 further shows that the vibration motors 108 can be daisy chained 304. The daisy chain 304 is a wire that goes from each vibration motor 108 to subsequent vibration motors 108. Daisy chaining 304 ensures that when one vibration motor 108 is turned on that all vibration motors 108 are all turned on. I.e., the daisy chain 304 ensures that all vibration motors 108 are either turned on or off.

The vibration motors 108 can be operated at specific frequencies to ensure that whatever frequency is most beneficial to a pet can be used. For example, the vibration frequencies can be approximately 90.73 hertz, 136.10 hertz and 204.15 hertz. The user can select the frequency that is most beneficial to their pet.

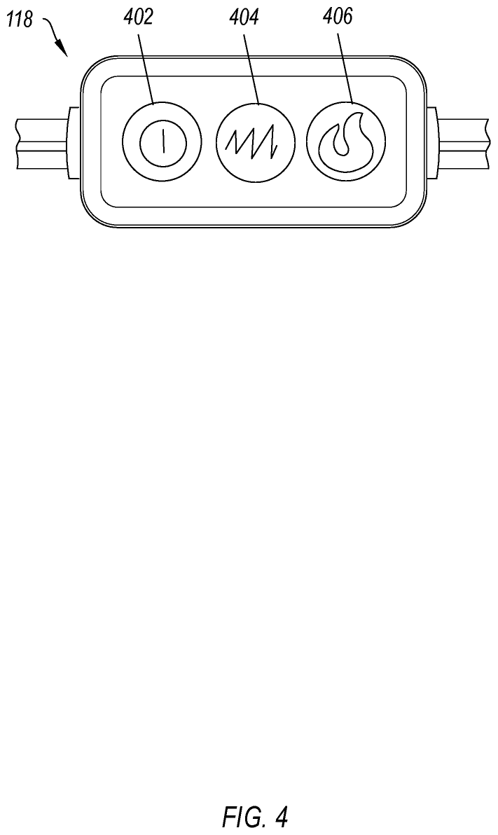

FIG. 4 illustrates an example of a control 118. The control 118 allows a user to select functions based on the needs of his/her pet. For example, some pets may prefer heat, some may prefer vibration, and others may prefer both. In addition, the control 118 can allow a user to select a vibration frequency. The control 118 can include a timer which turns off power after a certain duration. For example, the control 118 can turn off on any function which has been on for 15 minutes.

FIG. 4 shows that the control 118 can include a power button 402. The power button 402 allows a user to turn on and off the therapeutic pet bed. I.e., the power button 402 is just a general on/off button. The power button 402 can include a lighting option (i.e., the power button 402 can glow or have a light indicator) that indicates to the user when power is on.

FIG. 4 also shows that the control 118 can include a vibration button 404. The vibration button 404 can allow a user to select whether vibration is occurring and at what speed. For example, the vibration button can be pushed once for 90.73 hertz, a second time for 136.10 hertz, a third time for 204.15 hertz and a fourth time to turn off vibration. The vibration button 404 can include a lighting option that indicates to the user when vibration is on.

FIG. 4 also shows that the control 118 can include a heat button 406. The heat button 406 allows a user to turn on the heating function of the therapeutic pet bed. In particular, the heat button 406 can be pressed a first time to begin the heating process and pressed a second time to turn of power to the heating layer 110. The heating button 406 can include a lighting option that indicates to the user when the heat is on.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A therapeutic pet bed, the therapeutic pet bed comprising:
a base, wherein the base is configured to rest on a support surface;
a cover, wherein:
the base is attached to the cover; and
the cover surrounds the other components of the therapeutic pet bed;
a foam base;
one or more vibration motors within the foam base;
a heating layer;
a pad, wherein the pad produces a rest area for the pet; and
a control, wherein the control is configured to allow a user to turn on and off the heating layer and the vibration motors.

2. The therapeutic pet bed of claim 1, wherein the base is anti-slip.

3. The therapeutic pet bed of claim 1, wherein the base includes rubber.

4. The therapeutic pet bed of claim 1, wherein the foam base is between 1.5 inches and 2.5 inches wide.

5. The therapeutic pet bed of claim 4, wherein the foam base is approximately 2 inches wide.

6. The therapeutic pet bed of claim 1, wherein the pad is between 0.75 inches wide and 1.25 inches wide.

7. The therapeutic pet bed of claim 6, wherein the pad is approximately 1 inch wide.

8. A therapeutic pet bed, the therapeutic pet bed comprising:
a base, wherein the base is configured to rest on a support surface;
a cover, wherein:
the base is attached to the cover;
the cover is removable;
the cover is washable; and
the cover surrounds the other components of the therapeutic pet bed;
a foam base;
one or more vibration motors within the foam base, wherein the vibration motors operate at the following frequencies:
90.73 hertz;
136.10 hertz; and
204.15 hertz;
a heating layer;
a pad, wherein the pad produces a rest area for the pet; and
a control, wherein the control is configured to allow a user to turn on and off the heating layer and the vibration motors.

9. The therapeutic pet bed of claim 8, wherein the cover includes:
a lower cover; and
an upper cover, the upper cover configured to attach to the lower cover.

10. The therapeutic pet bed of claim 8, wherein the heating layer includes a heating wire.

11. The therapeutic pet bed of claim 8, wherein the heating layer includes a fabric mesh.

12. The therapeutic pet bed of claim 8, wherein the heating layer heats to approximately 102 degrees F.

13. A therapeutic pet bed, the therapeutic pet bed comprising:
a base, wherein the base is configured to rest on a support surface;
a cover, wherein:
the base is attached to the cover;
the cover is removable;
the cover is washable; and
the cover surrounds the other components of the therapeutic pet bed;
a foam base;
one or more vibration motors within the foam base, wherein:
the vibration motors operate at the following frequencies:
90.73 hertz;
136.10 hertz; and
204.15 hertz;
each vibration motor is:
housed within a bracket; and
daisy chained to the other vibration motors
a heating layer, wherein the heating wire includes:
a fabric mesh; and
a heating wire embedded within the fabric mesh;
a pad, wherein the pad produces a rest area for the pet;
batting attached along one or more edges of the pad, wherein the batting includes a fabric exterior filled with cotton;
an inner cover, wherein the inner cover is interior to the cover and surrounds the other components of the therapeutic pet bed; and
a control, wherein the control:
is configured to allow a user to turn on and off the heating layer and the vibration motors; and
includes:
a power button;
a vibration button; and
a heating button.

14. The therapeutic pet bed of claim 13, wherein the bracket is rubber.

15. The therapeutic pet bed of claim 13, wherein the pad includes memory foam.

16. The therapeutic pet bed of claim 13, wherein the batting is between 2 inches and 4 inches high.

17. The therapeutic pet bed of claim 16, wherein the batting is approximately 3 inches high.

18. The therapeutic pet bed of claim 13, wherein the control turns off the heating after approximately 15 minutes.

19. The therapeutic pet bed of claim 13, wherein the control turns off the vibration motors after approximately 15 minutes.

20. The therapeutic pet bed of claim 13, wherein each button on the control includes a light indicator.
